(19) United States
(12) Patent Application Publication
(10) Pub. No.: US 2009/0313961 A1
(43) Pub. Date: Dec. 24, 2009

(54) Self-propelled harvesting vehicle for crop material for technical use

(76) Inventor: Horst Weigelt, Guetersloh (DE)

Correspondence Address: STRIKER, STRIKER & STENBY, 103 EAST NECK ROAD, HUNTINGTON, NY, 11743, US

(21) Appl. No.: 12/485,474

(22) Filed: Jun. 16, 2009

(30) Foreign Application Priority Data
Jun. 19, 2008 (DE) 10 2008 028 859.4

(51) Int. Cl. A01D 41/127

(52) U.S. Cl. 56/10.2 B

(57) ABSTRACT

A self-propelled harvesting vehicle includes a crop material pick-up device, a fragmentation step for fragmentizing the crop material, and a mechanical dehydration device which is used to remove an aqueous portion of the crop material, and which is divided into a first dehydration step that takes place upstream of the fragmentation step, and a second dehydration step that takes place downstream of the fragmentation step.

### CROSS-REFERENCE TO RELATED APPLICATION

The invention described and claimed hereinbelow is also described in German Patent Application DE 10 2008 028 859.4 filed on Jun. 19, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a self-propelled harvesting machine that is especially adapted for the harvesting of crop material to be used for technical purposes, in particular for energy-related purposes.

Due to rapidly increasing costs for fossil fuels, techniques for obtaining fuel from sustainable raw materials have recently become the focus of greater public interest.

One problem that exists with most of the techniques used to obtain fuel from biomass is the high water content of the biomass in its fresh state. When fresh biomass must be hauled to a stationary facility where it is processed into fuel, large quantities of water that are present in the biomass are also transported, thereby resulting in high transport costs and, ultimately, high energy expenditures. If this factor is added to the energy “balance sheet” for a fuel obtained from biomass, the result is low efficiency, and even negative efficiency in certain circumstances. Therefore, it is important to minimize the distances covered between the field and the processing facility, and to minimize the amount of mass that is hauled.

To reach this goal, DE 10 2004 003 011 A1 provides that the processing system be brought to the crop material on the field, as part of a self-propelled harvesting machine, and that the crop material be processed into fuel directly on the field. This known harvesting machine includes a processing module for fragmentizing and compressing the harvested biomass, thereby separating the harvested biomass into a solid portion and a portion composed of plant juices. The portion of solid material obtained in this manner is then dried, in order to reduce its water content to the extent that the material may be processed further in an oiling module to obtain gasoline, Diesel oil, and heavy oil. In order to process the harvested biomass into fuel during the harvesting process itself, the processes mentioned must take place quickly, which, in the case of drying in particular, is not possible without the addition of a considerable amount of energy from an external source. Since the energy used in this case for drying also reduces the efficiency of the entire process to a considerable extent, it is important to remove so much moisture from the biomass by mechanical means that the drying may take place using a minimal amount of energy, or so that the drying step may be eliminated entirely.

### SUMMARY OF THE INVENTION

The present invention achieves this aim in that, in the case of a self-propelled harvesting vehicle that includes a crop material pick-up device, a fragmentation step for fragmentizing the crop material, and a mechanical dehydration device for removing an aqueous portion of the crop material, the mechanical dehydration device includes a first dehydration step that is upstream of the fragmentation step, and a second dehydration step that is downstream of the fragmentation step.

Given that the water that is weakly bound in the cellular structure of the harvested plant material is removed in the first dehydration step, and the plant material is then fragmentized, a material is obtained that has a cellular structure that has been weakened due to the removal of water which took place in the initial dehydration step. Water that is released from the plant cells in the second dehydration step may enter the open spaces—which were created in this manner—in the cellular structure relatively easily up to an interface with the particular piece of plant material, and then exit the remaining solid material. Given that the first mechanical dehydration step and the fragmentation process open up the biomass in this manner for the subsequent, second dehydration step, it is possible to obtain a dehydrated biomass having a particularly low content of residual water in a short period of time and using very little drive energy from fresh biomass. The first dehydration step preferably utilizes at least one pair of compression rollers which forms compression gap through which the harvested biomass passes.

The second dehydration step, in which the fragmentized biomass is dehydrated further, preferably utilizes a decanter or a screw extruder, both of which are suited for use to rapidly process large quantities of fragmentized material.

A heating device may be provided in order to heat the biomass that passes through the second dehydration step. The heating opens up the cellular structure of the material further, thereby further facilitating the dehydration process. Since this heating step is only used to further open up the cells of the biomass, but not to evaporate the moisture that remains, the output required of the heating device is minimal compared to the heat output that would be required to dry the biomass using the conventional method.

The dehydration device and the fragmentation step are preferably designed or may be operated such that the second dehydration step yields dehydrated crop material having a dry-mass portion of at least 60%, and even better, of at least 70%. This dehydrated crop material is composed essentially of cellulose, regardless of the type of plant that was harvested.

A heat-treatment step preferably takes place downstream of the second dehydration step. This heat-treatment step may include, in particular, a thermochemical reactor for carbonizing the dehydrated crop material into gaseous and/or liquid and/or solid reaction products.

If, as mentioned above, a heating device is provided for heating the crop material that passes through the second dehydration step, the heat dissipated from this reactor may be used to supply the heating device.

The heat-treatment step may also include a drying step. The drying step may be used simply to obtain crop material that has been dehydrated further, thereby rendering it easy to haul and store; it may also take place upstream of the thermochemical reactor in order to supply it with highly dehydrated raw material for carbonization.

In order to dry the crop material obtained in the second dehydration step quickly and efficiently, the drying step may include means for adding a hot thermal transfer material to the crop material to be dried.

When the heat-treatment step includes the reactor, the thermal transfer material is preferably a reaction product of the reactor. The reaction product generally leaves the reactor at a high temperature, and it is desirable to cool the reaction product before transferring it to a tank for storage.

The reactor generally yields gaseous, liquid, and/or solid reaction products, i.e. gas, oil, and/or coke. When gaseous reaction products, as the thermal transfer material in the drying step, are blown into the biomass to be dried, they mix with water vapour from the biomass, but they do not remain in the biomass to a noteworthy extent, thereby eliminating the need to use special devices for separating the reaction product from the biomass. It is also feasible to add solid reaction product (coke) to the mixture in order to heat the biomass. In this case, it is difficult to separate the two before they enter the reactor. In this case, the coke is simply returned to the reactor together with the fresh biomass.

The thermal transfer material that is added is preferably liquid (oil). This ensures that heat is transferred very rapidly and effectively from the thermal transfer material to the biomass via wetting and mixing.

In this case, a separation step—provided in the form of a compressor, in particular—is preferably situated between the drying step and the reactor in order to separate the oil from the biomass, and to remove the oil, as the yield of the process. It is therefore unnecessary to reheat the oil by passing it through the reactor once more. Only a remaining portion of the oil that was not removed in the separation step passes through the reactor once more. Since this remaining portion does not become lost when it passes through the reactor, it is not necessary to place high requirements on the extent to which separation is carried out in the separation step.

Even if the heat-treatment step does not include the reactor, it is expedient to include the separation step to remove the thermal transfer material, in order to recover it, reheat it, and transfer it to the drying step.

It may be advantageous to supply hydrogen gas to the reactor in order to reduce the content of oxygen remaining in the oil that is obtained, or to adjust the ratio of oxygen to carbon in the oil that is obtained, and, therefore, to adjust the length of its carbon chain to a desired value.

An electrolysis step, in which the aqueous portion that is removed in the dehydration device is electrolyzed, may be used to obtain the hydrogen.

A condensation step is preferably provided in order to capture the reaction products that were released in the reactor as vapor. The condensation step is also used to capture water that was carried in with the biomass or that was produced in the reactor, and that negatively impacts the quality of the condensate. In order to release a water-rich condensate obtained in the condensation step from hydrocarbon portions, the condensate may be sent through a filter, to which coke obtained in the reactor may be added, as the filter material. In this manner, purified water may be deposited directly onto the field, as excess water from the mechanical dehydration steps. The coke, which is saturated in the filter with organic components, may be sent to the reactor, directly or indirectly.

Gaseous reaction products, in particular those that remain after the passage through the condensation step since they are non-condensable, are preferably used in the harvesting vehicle itself as energy carriers, in particular to heat the reactor.

A concentration step which captures the aqueous portion that was removed in at least one of the dehydration steps may also be provided, in order to separate the aqueous portion into a portion that is enriched with dissolved substances, and into a portion from which dissolved substances were removed. While the enriched portion is generally collected in a tank of the harvesting vehicle for further processing, the portion from which dissolved substances were removed is preferably left on the field, as described above.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic depiction of the processing devices of the harvesting vehicle according to the present invention, in a first embodiment; and

FIG. 2 which is analogous to FIG. 1, is a schematic depiction of a second embodiment.

### DESCRIPTION OF THE PREFERRED EMBODIMENTS

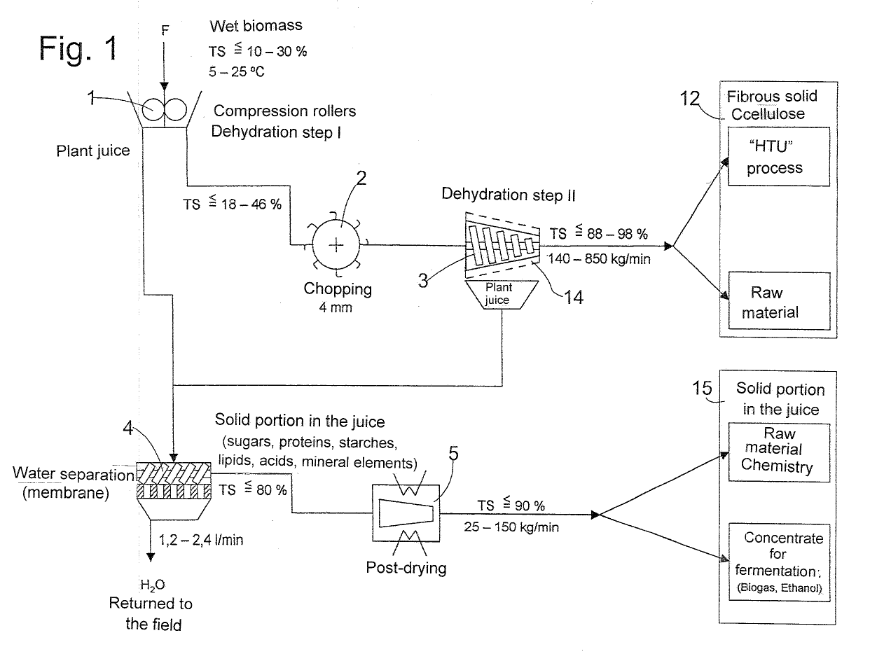

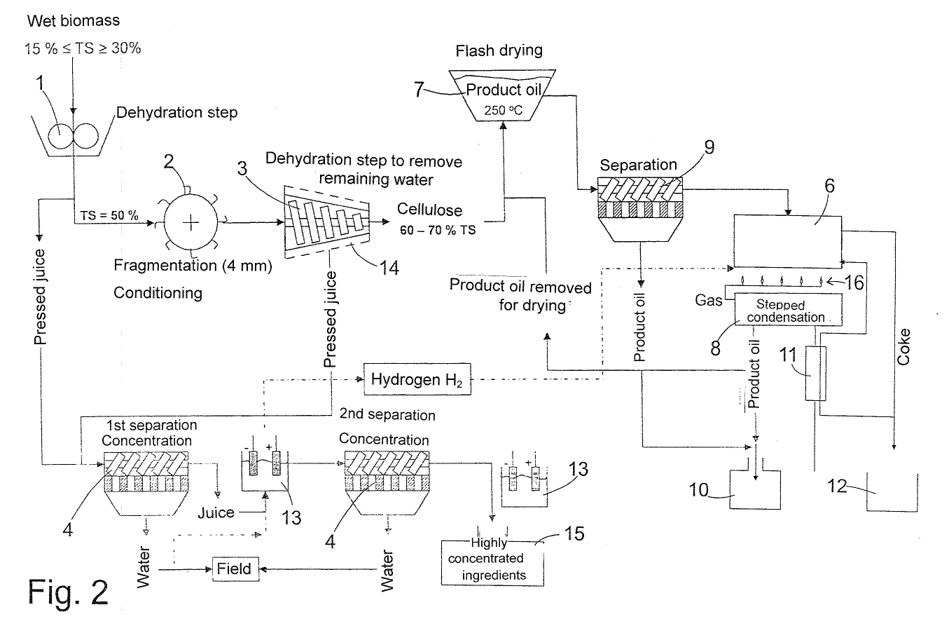

An external view of the harvesting vehicle according to the present invention is not shown, since its external design—provided it is not that of a conventional combine harvester or a forage harvester—depends essentially only on the requirement that the devices shown in FIGS. 1 and 2 be accommodated therein. Akin to a conventional forage harvester or combine harvester, the harvesting vehicle includes a ground drive, on the front of which a crop material pick-up device is mounted in a replaceable manner. The crop material pick-up device is identical to that of a conventional forage harvester or combine harvester, and it may be used in a replaceable manner thereon and on the harvesting vehicle according to the present invention.

Two compression rollers 1 form a gap toward which the harvested biomass is conveyed by the pick-up device. Depending on the type of plant material involved, when the biomass passes through compression rollers 1, it loses approximately half of its water; while the portion of the dry mass in the freshly picked-up biomass is between 10% and 30%, the portion of dry mass that remains after the biomass passes through compression rollers 1 has increased to 18% to 46%.

The biomass which was pre-dehydrated using compression rollers 1 then passes through a chopping step 2 which, as in the case of a forage harvester, may include a rotating cutting roller and stationary knives which interact therewith. The fragmentation is more intensive than it is in the case of a forage harvester, e.g. due to the knives being placed more closely together, or due to the biomass remaining in chopping step 2 for a longer period of time, with the result that when the material leaves the chopping step, particles having a typical maximum size of 4 mm are obtained.

The fragmentized material obtained in the chopping step 2 is sent to a second dehydration step 3, e.g. a decanter or a sieve centrifuge. In conjunction with the intensive fragmentation, this makes it possible to increase the portion of dry mass to 88% to 98%. The fibrous, cellulose-rich solid material obtained in this manner, the mass of which now comprises only approximately 10% to 30% of the biomass that was originally picked up, is collected in a bunker 12 on board the vehicle. It has a much higher specific energy content than that of the fresh biomass, thereby making it cost-effective to transport it further to a stationary processing facility. Due to the reduction in weight, the route along which the dehydrated material may be transported in a cost-effective manner is three to ten times longer than it is in the case of fresh, non-dehydrated biomass. The surface area from which a central processing facility may be supplied in a cost-effective manner, and the income from material that may be processed in a cost-effective manner surrounding a facility of this type is therefore increased approximately 10 to 100-fold. This results in considerable economies of scale for the operation of the facility.

To improve the water-removal process in second dehydration step 3, it may be provided that the biomass passes through the second dehydration step in the warmed state, e.g. by designing the walls themselves as heat exchangers 14, the walls being the walls which are in contact with the biomass and which belong to a conveyance path on which the biomass is conveyed between chopping step 2 and second dehydration step 3, or the walls of second dehydration step 3.

In the simplest case, the water that is removed in dehydration steps 1 and 3 could be deposited directly onto the field. It is expedient, however, to also remove any remaining components in a concentration step 4 that are economically useful, such as sugars, proteins, starches, lipids, acids, or mineral elements, e.g. using a membrane filter or several filters of this type which are connected in series. Using known filtration technologies, it is possible in this manner to generate a flow which is enriched with valuable components and has a dry-mass portion of up to 80 per cent, the remainder being water from which the valuable components have been largely removed, the water being deposited onto the field.

In a post-drying step 5, the portion of solid material in the enriched flow may be increased to up to 90 per cent. The concentrate which is obtained in this manner is collected in a tank 15 on-board the harvesting vehicle for further use, e.g. as feed, as a raw material for the chemical industry, or as a raw material for fermentation processes to create biogas or ethanol.

FIG. 2 shows an embodiment of the harvesting machine according to the present invention, in the case of which the processing carried out on-board the harvesting machine is more extensive than that carried out in the embodiment depicted in FIG. 1. Dehydration steps 1, 3 which utilize compression rollers and a decanter or a centrifuge, chopping step 2 situated therebetween, and concentration step 4 for concentrating the valuable components in the pressed-out liquid are the same as those shown in the embodiment in FIG. 1.

A flash pyrolysis reactor 6 is also located on-board the vehicle; it is supplied with the dehydrated, solid material that was obtained from the fresh biomass and that is composed mainly of cellulose. This material is heated in reactor 6 in the absence of air, thereby converting it in a continual process into water, various hydrocarbons, and a residual portion of solid material that is composed essentially of carbon, and is referred to as coke. The reaction products that are released as gas at the high temperature of reactor 6 are sent to a condensation step 8 and are condensed into fractions having a different boiling point. In condensation step 8, non-condensable gas supplies burner 16 which heats reactor 6.

Fractionated condensation takes place in condensation step 8; parameters of the fractionation are defined such that a fraction essentially contains all of the water that entered reactor 6 with the biomass and that was created via the pyrolysis reactions that took place therein, while at least one further fraction which is referred to as product oil is composed essentially only of hydrocarbons. If product oil is obtained, it passes through heat exchanger 14—which was mentioned with reference to FIG. 1—of the decanter or centrifuge 3—into a tank 10, except for a portion, preferably a fraction that condenses at a high temperature, which is redirected in entirety or partially to condensation step 8 so that it may be added in a drying step 7 to the dehydrated biomass obtained in second dehydration step 3. Drying step 7 may include kneading or stirring tools to mix the oil with the dehydrated biomass. The high temperature of the product oil causes the moisture remaining in the biomass to evaporate, thereby making it possible to remove a mixture of product oil and essentially anhydrous biomass at the outlet of post-drying step 7.

Before this mixture reaches reactor 6, it passes through a separation step 9 in which the product oil is removed from the biomass under pressure. The product oil which is removed in this manner is collected in tank 10 along with the portion of product oil that was obtained in condensation step 8 and that was not sent to drying step 8.

According to a preferred development, a filter 11 is provided in order to clean the condensate fraction that was obtained in condensation step 8 and that is composed essentially of water. As the filter substrate, filter 11 uses a portion of the coke from reactor 6 which is conveyed continually through filter 11 in the counter-flow to the aqueous fraction, thereby saturating the aqueous fraction with the organic components. The water that is obtained via filtration may be deposited onto the field if necessary, after undergoing a post-cleaning step; the coke that is saturated with the organic portions may be collected together with the remaining coke from reactor 6 in a bunker 12, as the combustible material, or, depending on the extent of its saturation with water or organic material, it may be returned directly to reactor 6, as shown in FIG. 2, or it may be returned by the long route via drying step 7, to remove the organic components via distillation in reactor 6 and add them to the product oil.

According to another development of the present invention, an electrolysis cell 13 is provided, which is supplied with the enriched portion obtained in concentration step 4. Electrolysis cell 13 is supplied with frequency-modulated direct current in order to obtain a high yield of hydrogen using a reduced amount of energy. The hydrogen obtained via electrolysis is supplied to pyrolysis reactor 6. The increase in the hydrogen supply in reactor 6 attained in this manner improves the conversion of the oxygen bound in the biomass to water, thereby yielding an oil from the flash pyrolysis that contains less oxygen and is therefore of higher quality.

It will be understood that each of the elements described above, or two or more together, may also find a useful application in other types of constructions differing from the types described above.

While the invention has been illustrated and described as embodied in a self-propelled harvesting vehicle for crop material for technical use, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A self-propelled harvesting vehicle, comprising a crop material pick-up device; a fragmentation step for fragmenting the crop material; and a mechanical dehydration device for removing an aqueous portion of the crop material, said mechanical dehydration device including a first dehydration step that is located upstream of said fragmentation step, and a second dehydration step that is located downstream of said fragmentation step.

2. The self-propelled harvesting vehicle as defined in claim 1, wherein said first dehydration step includes at least one pair of compression rollers which form a compression gap through which the crop material passes.

3. The self-propelled harvesting vehicle as defined in claim 1, wherein said second dehydration step includes an element selected from the group consisting of a decanter and a screw extruder.

4. The self-propelled harvesting vehicle as defined in claim 1, further comprising a heating device for heating the crop material that passes through said second dehydration step.

5. The self-propelled harvesting vehicle as defined in claim 1, wherein said second dehydration step is configured so that it delivers dehydrated crop material having a dry-mass portion of at least 60%.

6. The self-propelled harvesting vehicle as defined in claim 1, wherein said dehydration device is configured so that it dehydrates the crop material composed substantially of cellulose.

7. The self-propelled harvesting machine as defined in claim 1, and further comprising a heat-treatment step provided downstream of said second dehydration step.

8. The self-propelled harvesting vehicle as defined in claim 7, wherein said heat-treatment step includes a thermochemical reactor for carbonizing a dehydrated crop material into reaction products selected from the group consisting of gaseous reaction products, liquid reaction products, solid reaction products, and combinations thereof.

9. The self-propelled harvesting machine as defined in claim 4, wherein said heating device is arranged so that it is supplied with heat dissipated from a thermochemical reactor of a heat-treatment step.

10. The self-propelled harvesting machine as defined in claim 8, wherein said heat-treatment step includes a drying step.

11. The self-propelled harvesting machine as defined in claim 10, wherein said drying step includes means for adding hot thermal transfer material to the crop material to be dried.

12. The self-propelled harvesting machine as defined in claim 11, wherein said means for adding hot thermal transfer material is configured for adding the thermal transfer material which is a reaction product of the thermal chemical reactor.

13. The self-propelled harvesting machine as defined in claim 11, further comprising a separation step for separating the added thermal transfer material from the dried crop material downstream of the drying step.

14. The self-propelled harvesting machine as defined in claim 13, wherein said separating step is located upstream of the reactor.

15. The self-propelled harvesting machine as defined in claim 8, further comprising means for supplying hydrogen gas into the reactor.

16. The self-propelled harvesting machine as defined in claim 15, further comprising an electrolysis step for obtaining hydrogen via electrolysis from the aqueous portion that was separated out in the dehydration device.

17. The self-propelled harvesting machine as defined in claim 8, further comprising a condensation step for condensing vaporous products of the reactor and removing an aqueous condensate; and a filter through which the aqueous condensate flows, and to which coke from the reactor is added as a filter material.

18. The self-propelled harvesting machine as defined in claim 17, further comprising a burner for heating the reactor and supplied with gaseous reaction product from the reactor.

19. The self-propelled harvesting machine as defined in claim 1, further comprising a concentration step which captures the aqueous portion that was removed in at least one of the dehydration steps for separation into a portion that is enriched with dissolved substances, and into a portion from which the dissolved substances have been removed.

20. The self-propelled harvesting vehicle as defined in claim 19, further comprising a collection tank provided for the enriched portion.
